(19) United States
(12) Patent Application Publication
(10) Pub. No.: US 2013/0187399 A1
(43) Pub. Date: Jul. 25, 2013

(54) Vacuum pump to pick up articles

(71) Applicants: Mesha DUKES, Las Vegas, NV (US); Steve SATOW, Henderson, NV (US)

(72) Inventors: Mesha DUKES, Las Vegas, NV (US); Steve SATOW, Henderson, NV (US)

(21) Appl. No.: 13/749,100

(22) Filed: Jan. 24, 2013

Related U.S. Application Data
(60) Provisional application No. 61/590,098, filed on Jan. 24, 2012.

(51) Int. Cl. B25J 15/06

(52) U.S. Cl. CPC B25J 15/0616
USPC 294/183

(57) ABSTRACT

A system for picking up and holding articles using a vacuum pump. Articles such as beads, stones, etc. are picked up and held using a hand piece. The hand piece is coupled to a vacuum pump via tubing. The hand piece has a release hole to control a vacuum. The hand piece further has an interchangeable tip which contacts the article to be picked-up. The interchangeable tip allow for various sized tips to be utilized.

### PRIORITY

This application claims priority to co-pending U.S. Patent Application Ser. No. 61/590,098 entitled “Vacuum pump for all types of beads, picks them up quickly,” filed on Jan. 24, 2012, the technical disclosure of which is hereby incorporated by reference in its entirety.

### BACKGROUND OF THE INVENTION

1. Technical Field

The present invention relates to a vacuum pump which picks up articles.

2. Description of Related Art

When picking up articles such as beads, rhinestones, Swarovski's, gems, etc., a person will have a problem with finding a tool to help them lift the article and set it where it needs to be. Often these articles are very small and cannot be properly held with a person's fingers. Consequently, it is desirable to have an apparatus for picking up, holding, and setting an article.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a depiction of a system in one embodiment;

FIG. 2 is a top view of a hand piece in one embodiment;

FIG. 3 is a side cross-sectional view of a hand piece in one embodiment;

FIG. 4 is a perspective view of a hand piece in use in one embodiment.

### DETAILED DESCRIPTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

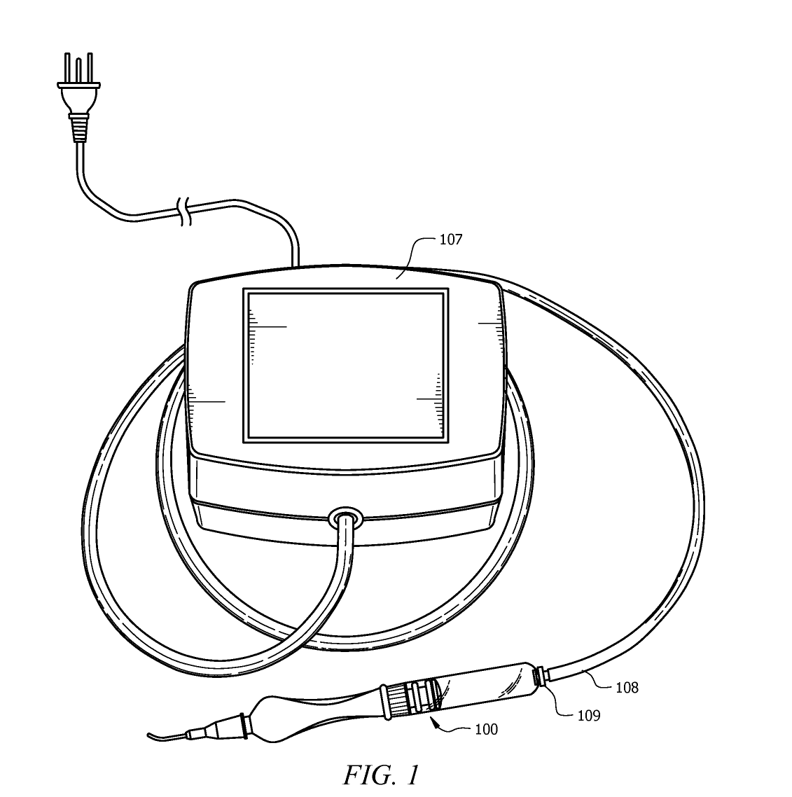

FIG. 1 is a depiction of a system in one embodiment. As depicted, the system comprises a vacuum pump 107, tubing 108, and a hand piece 100. The vacuum pump 107 can comprise virtually any type of vacuum pump. In one embodiment the vacuum pump 107 comprises a dual diaphragm air pump. The vacuum pump 107 can be plugged into an electrical outlet or it can run on battery power, solar, or the like. Vacuum pumps 107 with different amounts of power can be utilized. For example, picking up larger items can require a more powerful vacuum compared to smaller items. In one embodiment the vacuum pump 107 comprises a draw of about 12 SCFH. In one embodiment the vacuum pump 107 comprises an adjustable pump which allows the strength of the vacuum created to be adjusted. Thus, when a smaller item is being picked up the user can select a smaller vacuum, but when a larger item is being picked up the user can increase the vacuum provided by the vacuum pump 107.

The vacuum pump 107 can be of virtually any size and can be housed in virtually any fashion. In one embodiment the vacuum pump 107 is housed is plastic. Such a housing prevents moving parts from being damaged and offers increased safety for the user. In one embodiment the vacuum pump has only a single connection, whereas in other embodiments the vacuum pump has two or more connections allowing for the coupling of two or more hand pieces 100. Such embodiments allow multiple hand pieces 100 to be used with a single pump. Such embodiments decrease capital and work space by allowing a single piece of equipment, specifically a single vacuum pump, to support the operation of two or more work pieces 100.

Coupled to a vacuum pump 107 is tubing 108. Virtually any type of tubing of any length can be utilized. In one embodiment, to provide sufficient movement to the user, the tubing 108 comprises a length of about 4 feet.

In one embodiment the tubing 108 comprises a non-uniform diameter. A non-uniform diameter refers to a tubing which has a first diameter for a portion of the tubing and a second diameter for a different portion of the tubing, wherein the first and second diameters are different. For example, as shown in FIG. 1, the end of the tubing 108 which is coupled to the vacuum pump 107 comprises a larger diameter than the tubing 108 which is coupled to the hand piece. In one such embodiment a first tubing with a first diameter is coupled to the vacuum pump 107. The first tubing has a length of one foot. The first tubing is coupled to a second tubing having a second diameter which is coupled to the hand piece 100. In one embodiment, the first tubing has a diameter of between about 3-4 mm, and the second tubing has a diameter of between about 5-7 mm. The first and second tubings can comprise two separate tubings which are coupled together, or the first and second tubings can comprise a single tubing which comprises non-uniform diameters. A smaller tubing on the side which couples to the hand device 100 offers several benefits. First, smaller tubing typically results in a more flexible tubing, allowing the user to better move and control the hand device 100. Second, a smaller tubing restricts the air flow resulting in a stronger vacuum.

As noted, the tubing can comprise virtually any material. In one embodiment the tubing comprises silicone rubber, but it can also comprise other types of rubbers and plastics such as PVC. Rubber is easily bendable which provides the user freedom to move the hand piece 100.

As shown in FIG. 1 the tubing 108 is coupled to the hand piece 100. The tubing 108 can be coupled to the hand piece 100 with any device or method known in the art. In one embodiment the tubing 108 couples to a node 109 located on the hand piece 100.

As can be seen from the system of FIG. 1, when the vacuum pump 107 creates a vacuum, absent any leak in the system, a vacuum will be applied to the tip of the hand piece 100. This vacuum is used to pick up and hold articles, as will be discussed in more detail below.

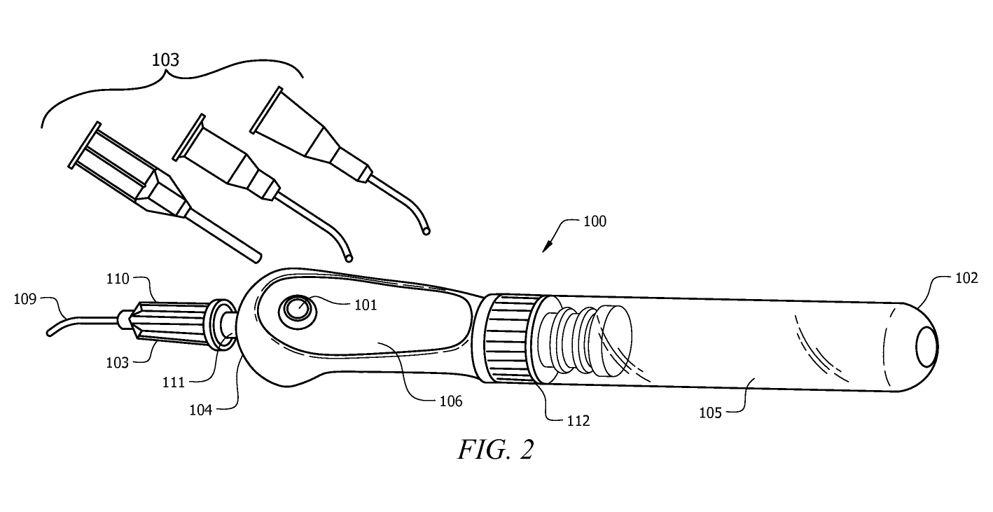

FIG. 2 is a top view of a hand piece in one embodiment. The hand piece 100 is the portion which is held by the operator and which is used to pick up and hold an article. As can be seen, the hand piece 100 comprises a top end 102 and a bottom end 104. In one embodiment the tubing 108 (shown in FIG. 1) will couple to the top end 102 of the hand piece 100.

As depicted, the hand piece 100 comprises an upper portion 105 and a lower portion 106. As shown, the lower 106 and upper 105 portions are removeably coupled via threading 112, however the portions can be coupled with any method known in the art such as snapping. Further, while the embodiment depicted shows an upper portion 105 and a lower portion 106, in one embodiment the hand piece 100 comprises only a single portion.

As shown, the upper portion 105 comprises a clear polypropylene test tube which is coupled to a flanged cap which comprises female threading 112. In one embodiment the test tube slides over and is removeably coupled to the female threading 112. The female threading 112 couples with the male threading of the lower portion 106. It should be noted that while FIG. 2 depicts the upper portion 105 comprising female threading, in other embodiments the upper portion 105 can comprise male threading.

A polypropylene test tube has a benefit that if glue is accidentally sucked inside, the glue is collected there as opposed to clogging other portions of the hand piece 100. The glue, or other items collected in the upper portion 105 can be emptied or removed by decoupling the upper portion 105 from the lower portion 106 and emptying the contents of the upper portion 105. By collecting articles in the upper portion 105, these articles are prevented from reaching and damaging the vacuum pump. In one embodiment the upper portion 105 comprises a filter to prevent articles from flowing to the vacuum pump. If portions of the hand piece 100 become clogged, they can be unclogged by inserting a tooth pick or a drill bit.

Any object smaller than the interchangeable tip 103, discussed below, can be sucked and deposited into the upper portion 105. These objects can be retrieved as discussed above. Thus, the hand piece 100 can be used to collect items and store them in the upper portion 105. In one embodiment the upper portion 105 is transparent to allow a user to see if an item has been either accidentally or intentionally collected. However, in other embodiments the upper portion 105 is not transparent.

The upper portion 105 maintains the vacuum generated by the vacuum pump 107. The upper portion 105 comprises at least two openings, one in fluid communication with the tubing 108 and one in fluid communication with the lower portion 106. By being in fluid communication with the lower portion 106, a vacuum generated by the vacuum pump 107 can be transferred and maintained in the upper 105 and lower 106 portions.

In one embodiment, the lower portion 106 comprises at least three openings. The first opening is in fluid communication with the upper portion 105 as described above. The second opening is in fluid communication with the interchangeable tip 103 and is discussed in more detail below. These openings allow a vacuum generated at the vacuum pump 107 to be passed and maintained in the tubing 108, the upper portion 105, the lower portion 106, and the interchangeable tip 103. The third opening is a release hole 101 which allows the vacuum to be broken, causing the article to be released.

While being depicted in the lower portion 106, the release hole 101 can also be located on the upper portion 105. The release hole 101 can be located anywhere between the interchangeable tip 103 and the pump 107. The release hole 101 can also be located on the pump 107. In one embodiment, however, the release hole 101 is located between the top end 102 and the bottom end 104 of the hand piece 100. Being located on the hand piece 100 provides the user the advantage of controlling the release hole 101 with the same hand which is controlling the hand piece 101, allowing the user to control the hand piece and release hole 101 with a single hand. Thus, a single user can operate two hand pieces, one in each hand, simultaneously. Further, being located on lower portion 106 allows the user to hold the hand piece as if holding a pencil, and allows the release hole 101 to be controlled with a thumb or finger.

In one embodiment the lower piece 106 is designed so as to be held like a pencil with the finger or thumb being located above the release hole 101 in a natural position. Thus, a user when holding the hand piece 101 naturally closes the release hole 101 completing the vacuum and picking up or holding the desired article. However, when the thumb or finger is lifted, the release hole 101 becomes open which breaks the vacuum and drops the article.

In one embodiment the release hole 101 has ridges around the periphery of the release hole 101 which rise above the surrounding plane. Put differently, the release hole 101 raises above so that it sticks out from the hand piece 101. Such an embodiment provides for increased sealing when the release hole 101 is closed. Because the release hole 101 has ridges which are above the surrounding plane, the release hole 101 is easier to close with a thumb or finger compared to an embodiment wherein the release hole simply comprises a hole without ridges.

The release hole 101 can comprise virtually any shape including circular, square, rectangular, etc. Further, the release hole 101 can comprise any size. In one embodiment the release hole comprises a diameter between about 0.5 to about 1 mm. In one embodiment the release hole comprises a diameter of about 0.75 mm.

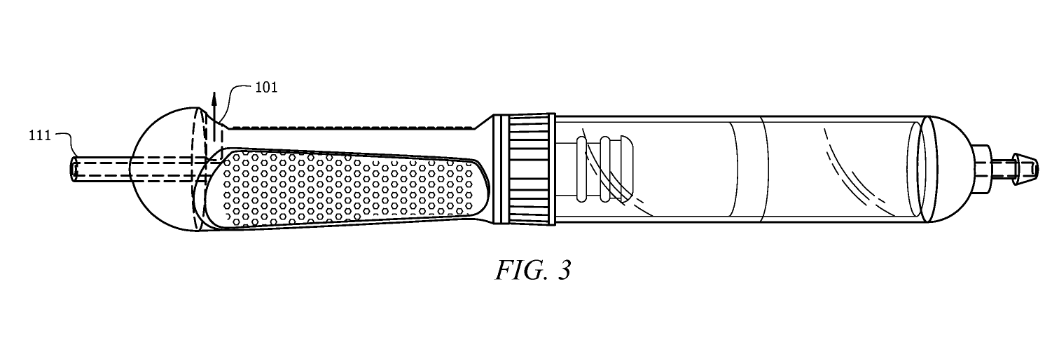

As noted, the release hole 101 is in fluid communication with the other openings in the lower portion 106 such that if the release hole 101 is closed the vacuum is maintained, whereas if the release hole 101 is open the vacuum is broken. Turning to FIG. 3, FIG. 3 is a side cross-sectional view of the hand piece in one embodiment. As can be seen, the hand piece 101 comprises an inner tube 111. As depicted, the lower portion 106 comprises a plastic molding which is molded over the inner tube 111. One purpose for this is that the plastic molding offers a more comfortable grip compared to using the inner tube 111 alone. As can be seen, the release hole 101 is coupled to a tunnel in the molding which couples the release hole 101 to the inner tube 111. The release hole 101, as depicted, can be coupled to the inner tube 111 via voids in the molding, or via a tube. Thus, the release hole 101 is in fluid communication with the inner tubing 111. As depicted, the inner tubing 111 extends beyond the molding of the lower portion 106 to couple to the interchangeable tip 103 (shown in FIG. 2). In one embodiment, the inner tubing 111 extends the length of the lower portion 106 and is in fluid communication with the upper portion 105 and the interchangeable tip 103. Thus, a vacuum is generated in the vacuum pump 107 and is transferred and maintained in the tubing 108, the upper portion 105, the inner tubing 111, the release hole 101, and the interchangeable tip 103. As noted, when the release hole 101 is open, the vacuum is broken and the article is dropped.

The inner tubing 111 can be made of virtually any material, including plastic, but in one embodiment comprises brass. Brass and other such metals are less susceptible to breaking after several interchangeable tips 103 have been placed on and taken off from the hand piece 100. The inner tubing 111 can comprise virtually any size but in one embodiment comprises a 5/32 of an inch diameter. The length of the inner tubing 111 can also vary, but in one embodiment it is between about 1 inch to about 4 inches, whereas in another embodiment the inner tubing 111 is about 3 inches in length.

As noted, coupled to the inner tubing 111 and/or the lower potion 106 is a interchangeable tip 103. An interchangeable tip 103 is a tip which is removeably coupled to the hand piece. An interchangeable tip 103 allows for difference sized tips to be utilized. For example, if a larger object is being picked up and held, a larger tip can be utilized.

An interchangeable tip 103 comprises a needle which concentrates the vacuum force in a specified area to allow an object to be picked up and held. By concentrating the vacuum force to a smaller area, the vacuum force can be better controlled.

In one embodiment the interchangeable tip 103 comprises a base 110 which couples the interchangeable tip 103 to the hand piece 100 via inner tubing 111 and/or lower portion 106, and a needle portion 109 coupled to the base 110. In one embodiment the base 110 comprises molded plastic. The needle portion 109 can comprise hypodermic needles which can be straight or bent. In one embodiment the needle portion 109 are blunted, meaning the ends are not sharp. Such an embodiment increases the safety of the hand piece 100.

The interchangeable tip 103 can come in a variety of sizes to suit a variety of needs. For example, in one embodiment the hand device 100 may comprise two or more different sized interchangeable tips 103. In one embodiment the interchangeable tips have sizes of 14, 16, and 18 ga. A user can select a suitably sized interchangeable tip 103 to pick up and hold a specific article.

To operate the system, the vacuum pump 107 is first activated. Thereafter, or simultaneous with the vacuum pump 107 being activated, the release hole 101 is closed with a finger or thumb. This ensures the vacuum is being transferred and felt by the interchangeable tip 103. The hand piece 100 is then manipulated by the user so that the needle portion 109 is near the article to be picked up by the hand piece 100. The vacuum force picks up the article. The user then manipulates the hand piece 100, which is now holding the article, and places the article at the desired location. Thereafter, the user opens the release hole 101 by unsealing the finger or thumb which was previously covering the release hole 101. The vacuum breaks, and the article is deposited at the desired location. The needle portion 109, which is now not under a vacuum, can be used to further position the article. The user can then seal the release hole 101 and grab another article. This system and method speeds up the process of picking up and placing articles, in some cases, by more than 75%. As noted, picking up a small bead with fingers is often very difficult. Often the bead must be picked up clumsily and placement of that bead will be inaccurate. However, the system and method allow the bead to be picked up at a desired location and orientation and deposited at a desired location and orientation.

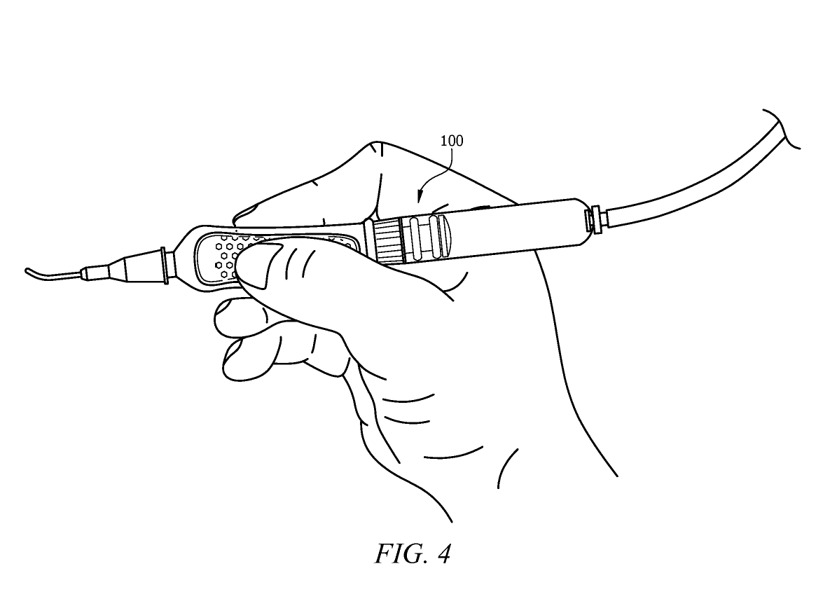

FIG. 4 is a perspective view of a hand piece in use in one embodiment. As depicted, in one embodiment the hand piece can be held like a pencil. Users are comfortable holding pencils, and thus will be able to freely maneuver and control the hand piece.

The system described can be used to pick up a variety of articles including beads, gems, rhinestones, diamonds, various stones, Swarovski's, etc. The system uses a vacuum to pick up the item, hold and manipulate the item, and place the item where desired. It can be used to decorate crafts, cakes, cupcakes, manufacture or repair jewelry or watches, etc. For example, the system can be used to place ready prongs for re-tipping gemstones or diamonds with a laser welder. Further, the system can be used for quality evaluation of gemstones, diamonds, and other items, including being used to pick up and hold items for evaluation under a lens or microscope. Other uses include, but are not limited to, sorting items such as gemstones, packing gemstones and other items for sale, placing items such as gemstones into mounting during a setting process. Another use is in pave setting of stones such as diamonds, gems, etc.

Virtually any type of item can be picked up, held, and placed. In one embodiment using a dual diaphragm air pump running on 115 volts with a draw of 12 SCFH, stones with diameters between 1.25 mm to 7 mm in diameter were picked up and held. Further a 2 carat stone was also picked up and held. The size and weight limitations will be restricted only by the power of the pump as well as the size of the interchangeable tip 103.

The system allows the user to easily pick up a single specific article even out of a pile of articles. For example, if the user desires a blue stone out of a pile of mixed colored stones, the system allows the blue stone to be isolated and picked up by the hand piece. As noted, when the vacuum is broken, the needle 109 can be used to manipulate and position the article. Thereafter, when the release hole 101 is sealed, the article can then be picked up by the hand piece. This ability to pick up a single desired article out of a pile saves significant time sorting and searching through the materials. Further, this system results in the saving of glue in one embodiment. Previously, tooth picks were dipped in glue to grab beads and other such articles. The article was then placed with a toothpick at the desired location. The toothpick needed to be dipped in fresh glue fairly frequently resulting in wasted glue. The hand piece, however, eliminates the need to dip a toothpick in glue.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.

1. A system for picking up an article, said system comprising:

a vacuum pump;

a hand piece coupled to said vacuum pump via tubing;

wherein said hand piece comprises a top end and a bottom end, wherein said hand piece further comprises an operating hole located between said top end and said bottom end to control a vacuum, wherein said hand piece further comprises an interchangeable tip.

2. The system according to clause 1 wherein said tubing is coupled to said top end of said hand piece.
3. The system according to any preceding clause wherein said hand piece comprises a two part molded plastic resin.
4. The system according to clause 3 wherein said hand piece comprises an inner tube.
5. The system according to any preceding clause wherein said hand piece comprises two parts, a lower portion and an upper portion, wherein said lower and upper portions are removeably coupled.
6. The system according to clause 5 wherein said upper and lower portions are coupled via threading.
7. The system according to clause 5 wherein said upper portion comprises a clear polypropylene test tube.
8. The system according to any preceding clause wherein said vacuum pump comprises a dual diaphragm pump.
9. The system according to any preceding clause wherein said vacuum pump comprises an adjustable pump.
10. The system according to any preceding clause wherein said tubing comprises a non-uniform diameter.
11. The system according to any preceding clause wherein said release hole comprises ridges around the periphery of the release hole, wherein said ridges rise above said hand piece.
12. The system according to any preceding clause wherein said interchangeable tip comprises a base and a needle portion, wherein said needle portion is coupled to said base.
13. The system according to clause 12 wherein said base comprises molded plastic.

What is claimed is:

1. A system for picking up an article, said system comprising:
a vacuum pump;
a hand piece coupled to said vacuum pump via tubing;
wherein said hand piece comprises a top end and a bottom end, wherein said hand piece further comprises an operating hole located between said top end and said bottom end to control a vacuum, wherein said hand piece further comprises an interchangeable tip.

2. The system of claim 1 wherein said tubing is coupled to said top end of said hand piece.

3. The system of claim 1 wherein said hand piece comprises a two part molded plastic resin.

4. The system of claim 3 wherein said hand piece comprises an inner tube.

5. The system of claim 1 wherein said hand piece comprises two parts, a lower portion and an upper portion, wherein said lower and upper portions are removeably coupled.

6. The system of claim 5 wherein said upper and lower portions are coupled via threading.

7. The system of claim 5 wherein said upper portion comprises a clear polypropylene test tube.

8. The system of claim 1 wherein said vacuum pump comprises a dual diaphragm pump.

9. The system of claim 1 wherein said vacuum pump comprises an adjustable pump.

10. The system of claim 1 wherein said tubing comprises a non-uniform diameter.

11. The system of claim 1 wherein said release hole comprises ridges around the periphery of the release hole, wherein said ridges rise above said hand piece.

12. The system of claim 1 wherein said interchangeable tip comprises a base and a needle portion, wherein said needle portion is coupled to said base.

13. The system of claim 12 wherein said base comprises molded plastic.
